(19) United States
(12) Patent Application Publication
(10) Pub. No.: US 2010/0128303 A1
(43) Pub. Date: May 27, 2010

(54) ENHANCEMENTS TO MULTI-PART JOB PROCESSING

(75) Inventor: Javier A. Morales, Rochester, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 12/323,735

(22) Filed: Nov. 26, 2008

(51) Int. Cl. G06F 3/12

(52) U.S. Cl. 358/1.15

(57) ABSTRACT

Print jobs often contain logically separable sections that can be processed independently and in parallel. Logical separability is often an aspect of different page sizes, color splits, and finishing. Split nodes can examine the page descriptions in a print job to identify splitting opportunities and to split the print job into multiple partial jobs. The partial jobs can then be separately processed to produce work product that is subsequently combined by a join node. The split and subsequently rejoined print job, if incomplete, can then be subjected to further processing, such as packing and shipping.

### TECHNICAL FIELD

Embodiments are related to printing and more specifically to the prepress processing and post press processing of print jobs having logically separable sections.

### BACKGROUND

In typical print shop operations, a user desiring a document issues a request resulting in a print job. The print job can then be processed manually by shop personnel, automatically by shop equipment and computers, or by a combination of manual and automatic operations. Prepress operations are those in which the print job is prepared for printing. Print jobs are often initially fairly generic and can be processed by most print shops. Prepress operations can transform a print job for a particular shop's equipment mix and capabilities.

A print job typically specifies at least one document description which is an electronic description of a desired document. The document description is commonly composed of page description language (PDL) instructions and data. The PDL specifies not only what is to be printed, but also how and onto what printing media.

Many print jobs have logically separable sections. For example, covers can by printed in color onto thick stock with a glossy finish. Most of the interior pages can be printed in black and white onto thinner page stock. Such a print job is often performed by serially printing one section after another until the job is complete. Systems and methods freeing print jobs from serialized work flows are needed.

### BRIEF SUMMARY

Aspects of the embodiments address limitations and flaws in the prior art by locating the separable sections of a print job and splitting it into multiple partial jobs that are separately processed and then joined.

It is therefore an aspect of the embodiments that a print job contains a number of page descriptions. In many cases, a print job contains a document description that specifies a desired document. The document description contains the page descriptions. A single page description specifies one particular page of the desired document. Note that a document description can be either the actual data specifying the document or can be a reference, pointer, or URL specifying the location of the actual data specifying the document. Similarly, a page description can be the actual data specifying the page or can be a reference, pointer or URL.

It is another aspect of the embodiments that a split node can examine the page descriptions to determine which pages descriptions to process separately from other page descriptions. The split node then splits the print job into partial jobs. Then each partial job can be processed separately because each partial job contains page descriptions that are to be separately processed.

It is yet another aspect of the embodiments that each partial job is processed to produce a work product. The various work products are then combined by a join node to reformulate the print job. The reformulated print job may be completely processed and require no more processing upon joining or may be in need of further processing.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention

FIG. 1 illustrates a system splitting, processing, and joining a print job in accordance with aspects of the embodiments;

FIG. 2 illustrates a system the splits a print job multiple times and joins multiple work products to produce a document in accordance with aspects of the embodiments;

FIG. 3 illustrates examples of splitting rules in accordance with aspects of the embodiments;

FIG. 4 illustrates scheduling and tracking of partial jobs and work products in accordance with aspects of the embodiments;

FIG. 5 illustrates a high level flow diagram of splitting print jobs and joining work product in accordance with aspects of the embodiments; and

FIG. 6 illustrates a high level flow diagram of splitting a print job in accordance with aspects of the embodiments.

### DETAILED DESCRIPTION OF THE INVENTION

The particular values and configurations discussed in these non-limiting examples can be varied and are cited merely to illustrate embodiments and are not intended to limit the scope of the invention.

Print jobs often contain logically separable sections that can be processed independently and in parallel. Logical separability is often an aspect of different page sizes, color splits, and finishing. Split nodes can examine the page descriptions in a print job to identify splitting opportunities and to split the print job into multiple partial jobs. The partial jobs can then be separately processed to produce work product that is subsequently combined by a join node. The split and subsequently rejoined print job, if incomplete, can then be subjected to further processing, such as packing and shipping.

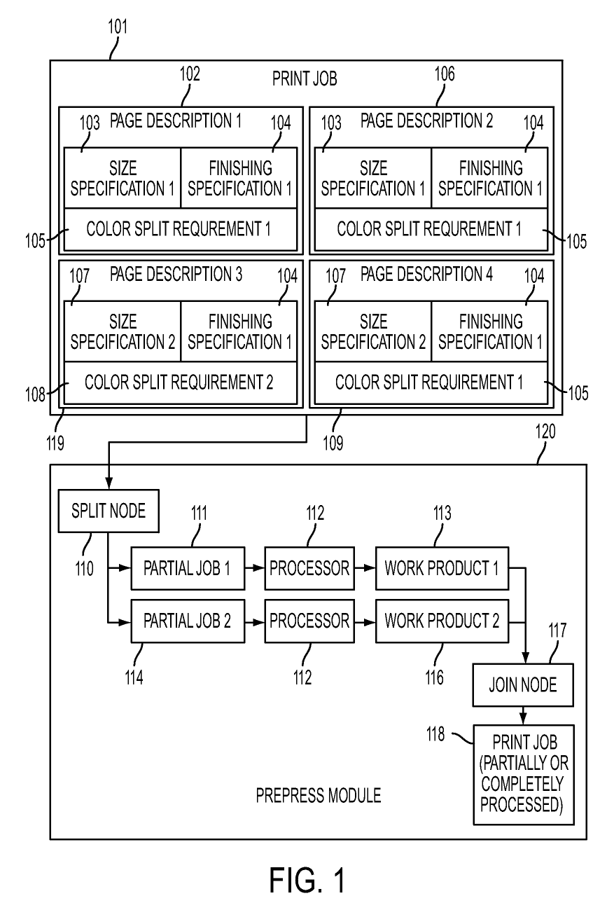

FIG. 1 illustrates a system splitting, processing, and joining a print job 101 in accordance with aspects of the embodiments. The print job 101 has four page descriptions. Page description 1 102 has size specification 1 103, finishing specification 1 104, and color split requirement 1 105. Page description 2 106 has size specification 1 103, finishing specification 1 104, and color split requirement 1 105. Page description 3 119 has size specification 2 107, finishing specification 1 104, and color split requirement 2 108. Page description 4 109 has size specification 2 107, finishing specification 1 104, and color split requirement 1 105. A page size specification specifies the page size such as letter size, tabloid size, etc. A finishing specification specifies the page finish such as matte or glossy. A color split requirement specifies the colors to be used which are typically black, cyan, magenta, yellow, or a combination thereof.

The print job 101 is passed to a prepress module 120 that contains a split node 110 and a join node 117. The split node 110 splits the print job into partial job 1 111 and partial job 2 114. Both partial jobs are operated on by a processor 112 to produce work product 1 113 and work product 2 116. Processor 112 is not necessarily a CPU but is whatever processor is required to form work product from partial job. As such, the processor can be a virtual machine, an interpreter, a filter, a computer program, or simply a CPU. A join node 117 combines the work products to reform the print job 118 which is now either partially or completely processed. Note that partially processed is most likely because nothing has yet been printed.

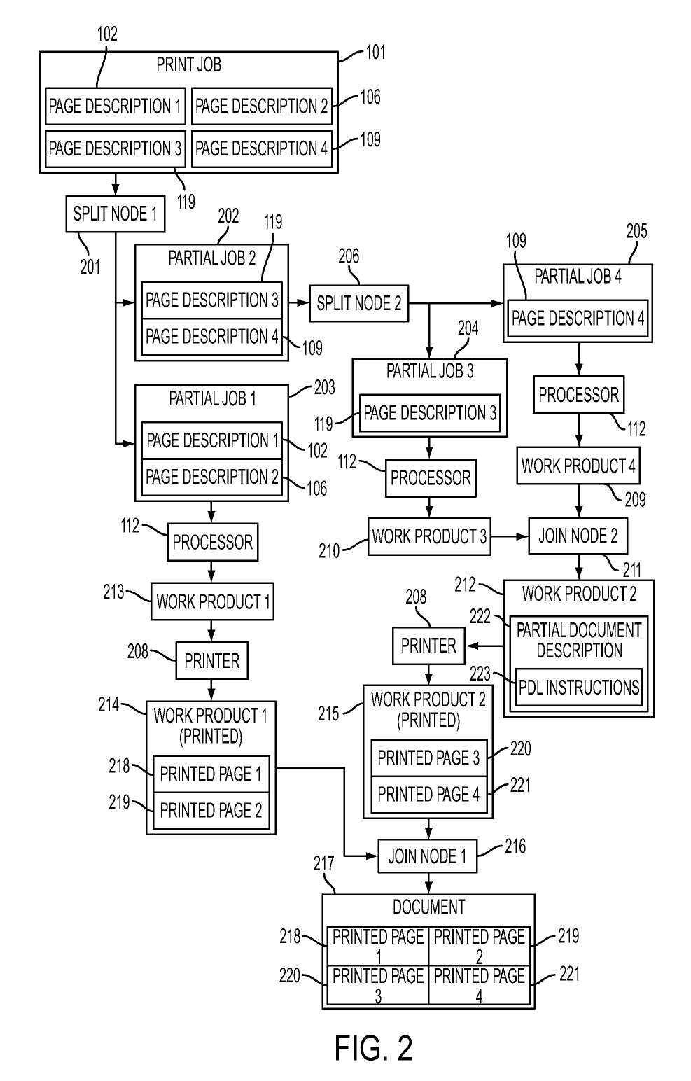

FIG. 2 illustrates a system the splits a print job 101 multiple times and joins multiple work products to produce a document 217 in accordance with aspects of the embodiments. Split node 1 201 splits the print job 101 based on page size specification into partial job 1 203 and partial job 2 202. A processor 112 process partial job 1 203, containing page description 1 102 and page description 2 106, to produce work product 1 208. Work product 1 213 is printed by printer 208 to produce printed work product 214 containing printed page 1 218 and printed page 2 219. Note that the processor 112 manipulates data whereas printer 208 prints pages.

Partial job 2 202 is further split by split node 2 206 based on color split requirement into partial job 4 205 and partial job 3 204. Partial job 3 204 contains page description 3 119 and is processed by processor 112 into work product 3 210. Partial job 4 205 contains page description 4 109 and is processed by processor 112 into work product 4 209. Work product 3 210 and work product 4 209 are joined by join node 2 211 to produce work product 2 212 containing a partial document description 222 composed of page description language (PDL) instructions and data 223.

Printer 208 prints work product 2 212 to produce printed work product 2 215 containing printed page 3 220 and printed page 4 221. Note the printer 208 refers to any printer or printers in general that can print the pages. As such, printer 208 can in one case refer to a black laser jet printer and to a color dye sublimation printer in another case. Regardless, the printed work products 214, 215 are joined at join node 216 to produce the final document 217.

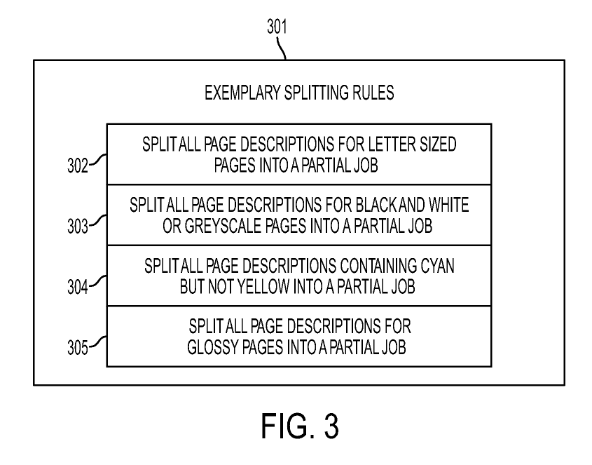

FIG. 3 illustrates examples of splitting rules 301 in accordance with aspects of the embodiments. A splitting node can be a rule based splitting node. As such, a rule editing module allows a user to create, delete, and edit splitting rules. Some exemplary splitting rules 301 are illustrated. One rule can be to split all page descriptions for letter size pages into a partial job 302. A second rule can be to split all page descriptions for black and white or grey scale pages into a partial job 303. A third rule can be to split all page descriptions containing cyan but not yellow into a partial job 304. Another rule can be to split all page descriptions for glossy pages into a partial job 305.

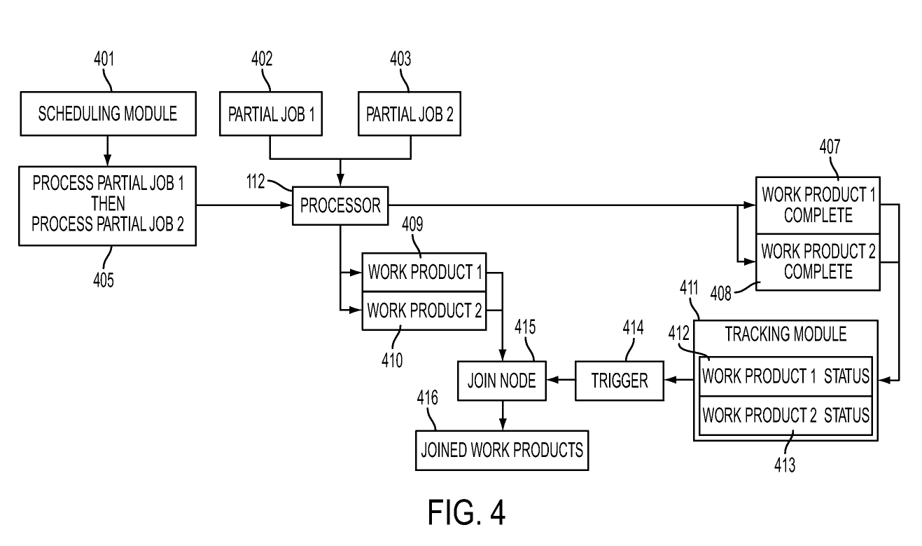

FIG. 4 illustrates scheduling and tracking of partial jobs and work products in accordance with aspects of the embodiments. A scheduling module 401 schedules a single processor 112 to process partial job 1 and then partial job 2 405. The processor 112 then obtains and processes partial job 1 402 to produce work product 1 409 and, upon completion, alert a tracking module 411 that work-product 1 is complete 407. Then the processor 112 obtains and processes partial job 2 403 to produce work product 2 410 and, upon completion, alert the tracking module 411 that work product 2 is complete 408. The tracking module 411 tracks job statuses which in the illustrated case are work product 1 status 412 and work product 2 status 413. The tracking module 411 sends trigger 414 to join node 415 when both work products are complete. The join node 415 then joins the work products to form joined work product 416.

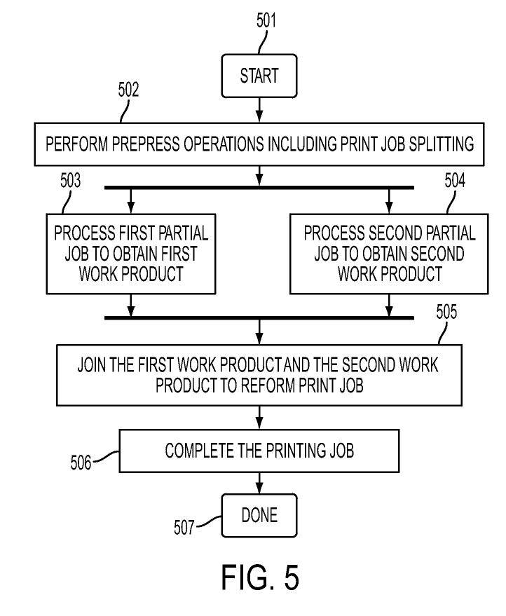

FIG. 5 illustrates a high level flow diagram of splitting print jobs and joining work product in accordance with aspects of the embodiments. After the start 501 prepress operations including print job splitting are performed 502. After splitting, two parallel execution paths exist. One path processes the first partial job to obtain the first work product 503. The other path processes the second partial job to obtain the second work product 504. After both parallel execution paths complete, the work products are joined to thereby reform the print job 505. The print job is then completed 506 before the process is done 507.

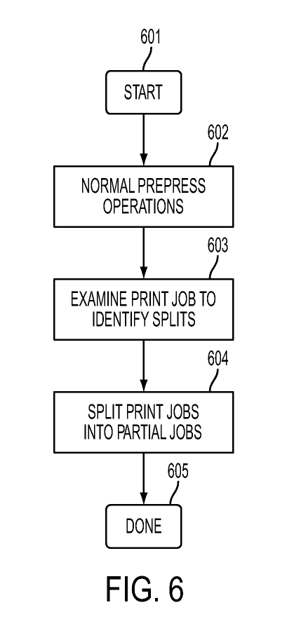

FIG. 6 illustrates a high level flow diagram of splitting a print job in accordance with aspects of the embodiments. In essence, the process flow of FIG. 6 is what occurs inside of block 502 of FIG. 5. After the start 601 normal prepress operations are performed 602 such as obtaining data, interpreting values and similar operations that would normally be performed on a print job that is not splittable. Next, the print job is examined to identify splitting opportunities 603 and then the print job is actually split into partial jobs 604 before the process is done 605.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
performing a plurality of prepress operations on a print job wherein an automated prepress module performs the prepress operations and wherein the prepress operations comprise examining the print job to distinguish a first partial job and a second partial job and wherein the prepress operations comprise producing the first partial job and the second partial job from the print job;
producing a first work product by processing the first partial job;
producing a second work product by processing the second partial job;
joining the first work product and the second work product; and
completing the print job.

2. The method of claim 1 wherein the first partial job and the second partial job are distinguished by page size specification.

3. The method of claim 1 wherein the first partial job and the second partial job are distinguished by color split requirement.

4. The method of claim 1 further comprising determining that the first work product is completely processed and that the second work product is completely processed before joining.

5. A system comprising:
a prepress module comprising a split node and a join node;
a print job comprising a plurality of page descriptions describing a plurality of pages; and
a printer that prints the pages;
wherein the split node splits the print job into a first partial job and a second partial job wherein the first partial job comprises at least one of the page descriptions and wherein the second partial job comprises at least one of the page descriptions;
wherein a first work product is produced from the first partial job;
wherein a second work product is produced from the second partial job;
wherein the printer prints the page descriptions to create a plurality of document pages; and
wherein the join node joins the first work product and the second work product to reformulate the print job.

6. The system of claim 5, wherein each page description within the first partial job comprises a first size specification and wherein no page description within the second partial job comprises any size specification.

7. The system of claim 5, wherein each page description within the first partial job comprises a first size specification and wherein no page description within the second partial job comprises a size specification equaling the first size specification.

8. The system of claim 5, wherein the first partial job comprises a first color split requirement and wherein the second partial job has no color split requirement.

9. The system of claim 5, wherein the first partial job comprises a first color split requirement and wherein the second partial job comprises no color split requirement equaling the first color split requirement.

10. The system of claim 5, wherein the first partial job comprises a first finishing specification and wherein the second partial job comprises no finishing specification equaling the first finishing specification.

11. The system of claim 5 wherein the first work product comprises a partial document description.

12. The system of claim 11 wherein the partial document description comprises a plurality of PDL instructions.

13. The system of claim 5 wherein the first work product comprises at least one printed page.

14. The system of claim 5 further comprising a tracking module that tracks all partial jobs and all work products and wherein the tracking module triggers the join node after the first work product and the second work product are processed or printed.

15. The system of claim 5 further comprising a scheduling module that schedules the first partial job and the second partial job for processing and schedules the first work product and the second work product for joining.

16. A system comprising:
a set of splitting rules;
a prepress module comprising a rule based split node and a join node;
a print job comprising a plurality of page descriptions; and
a printer;
wherein the split node splits the print job into a first partial job and a second partial job;
wherein a first work product is produced from the first partial job;
wherein a second work product is produced from the second partial job;
wherein the printer prints the page descriptions to create a plurality of document pages; and
wherein the join node joins the first work product and the second work product to reformulate the print job.

17. The system of claim 16 wherein the set of splitting rules comprises a rule to split based on size specification.

18. The system of claim 16 wherein the set of splitting rules comprises a rule to split based on color split requirement.

19. The system of claim 16 wherein the first work product comprises a partial document description.

20. The system of claim 16 wherein the first work product comprises a printed page.
